(19) United States
(12) Patent Application Publication
(10) Pub. No.: US 2012/0104815 A1
(43) Pub. Date: May 3, 2012

(54) OCCUPANT RESTRANT SYSTEMS HAVING TENSIONING DEVICES, AND ASSOCIATED METHODS OF USE AND MANUFACTURE

(75) Inventors: Peter Edward Miller, Phoenix, AZ (US); Ian John Hadlow, Worcester (GB); Derrick John Martin Barker, Bishampton (GB); Andrew Charles Peters, Bromsgrove (GB); Sean Leonard Rory Casey, Waterlooville (GB)

(73) Assignee: AmSafe Commercial Products, Inc., Elkhart, IN (US)

(21) Appl. No.: 13/234,074

(22) Filed: Sep. 15, 2011

Related U.S. Application Data
(60) Provisional application No. 61/383,271, filed on Sep. 15, 2010.

(51) Int. Cl. B60N 2/26; B60R 22/10

(52) U.S. Cl. 297/250.1; 297/464; 24/163 R

(57) ABSTRACT

The present disclosure is directed to tensioning devices and associated systems for use with child seats and other personal restraint systems. In one embodiment of the disclosure, a buckle includes a manual tensioning device configured to provide fine-tuning of harness tension when securing an occupant (e.g., a child) in a safety seat. In another embodiment, tensioning components can be configured to provide a means of dynamically adding tension in a restraint harness during crash event.

### CROSS-REFERENCE TO RELATED APPLICATION(S) INCORPORATED BY REFERENCE

The present application claims the benefit of and priority to U.S. Provisional Patent Application No. 61/383,271, filed Sep. 15, 2010 and incorporated herein in its entirety by reference.

### TECHNICAL FIELD

The following disclosure relates generally to occupant restraint systems for use in vehicles and, more particularly, to buckle assemblies for use with child seats and other personal restraint systems.

### BACKGROUND

There are many types of personal restraint systems for use in automobiles, aircraft, all-terrain-vehicles, and other vehicles. Such systems include, for example, seat belts for use by adults and children of sufficient size, and child seats with associated restraints for use by toddlers and small children.

One method of securing seat belts or webs around an occupant in a child seat includes releasably attaching the webs to a buckle assembly. The buckle assembly retains the webs around the occupant during use, and can be released to separate the webs after use. Conventional buckle assemblies can allow for some amount of slack in the webs during use. Excessive slack in the webs, however, can reduce the effectiveness of the restraint system, especially during a crash event.

In other conventional buckle assemblies, the web adjusting device may be positioned on a shell of a safety seat such that a caretaker of a child needs to use two hands—one for releasing a spring loaded cam and the other for pulling a web through slots in the shell of the safety seat. This action can be awkward to perform, as the caretaker of a child may only have one hand available.

Accordingly, it would be advantageous to provide child restraint systems having buckles and related components that, among other things, reduce the amount of slack in the webs of a buckle during use and facilitate a one-handed release of the buckle.

### BRIEF DESCRIPTION OF THE DRAWINGS

FIG. 1 is an isometric view of a child secured in a child seat with a restraint system having a buckle assembly configured in accordance with an embodiment of the disclosure.

FIGS. 2A and 2B are front isometric views of a buckle assembly having a tensioning system configured in accordance with an embodiment of the disclosure.

FIGS. 3-5 are schematic side views of various tensioning devices configured in accordance with embodiments of the disclosure.

FIGS. 6A and 6B are front isometric views of a buckle assembly having a tensioning system configured in accordance with another embodiment of the disclosure, and FIGS. 6C and 6D are side views of the buckle assembly of FIGS. 6A and 6B.

FIGS. 7A and 7B are cross-sectional side views of a buckle assembly having a tensioning system configured in accordance with a further embodiment of the disclosure, and FIG. 7C is an enlarged schematic side view of a sensor of the tensioning system of FIG. 7A.

FIGS. 8-11 are side cross-sectional views of safety seats with buckle assemblies and tensioning devices configured in accordance with additional embodiments of the disclosure.

### DETAILED DESCRIPTION

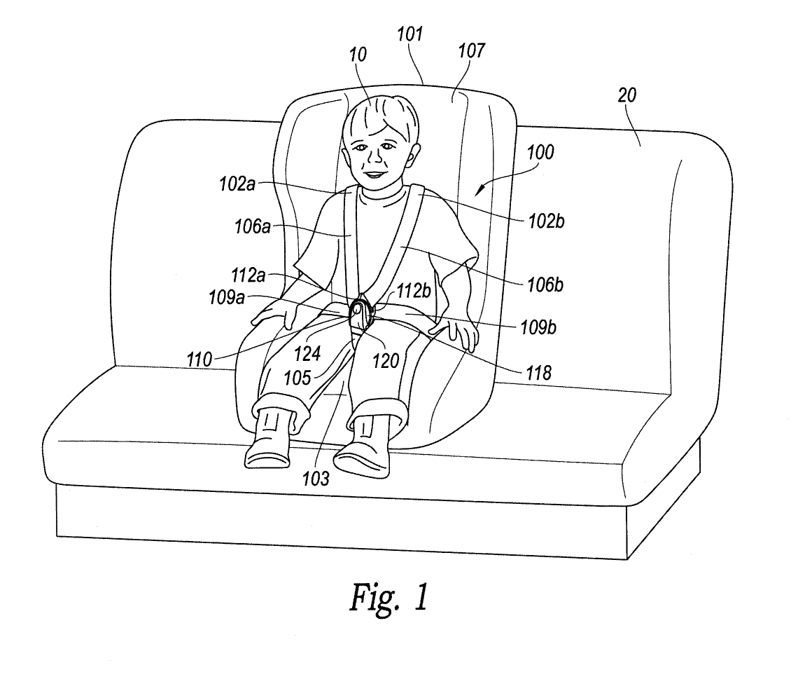

The following disclosure describes tensioning devices and associated systems for use with child seats and other personal restraint systems. As described in greater detail below, in one embodiment a buckle has a manual tensioning device configured to provide fine-tuning of harness tension when securing an occupant (e.g., a child) in a safety seat. In another embodiment, tensioning components can be configured to provide a dynamic means of adding harness tension in a crash event. Certain details are set forth in the following description and in FIGS. 1-11 to provide a thorough understanding of various embodiments of the disclosure. However, other details describing well-known structures and systems often associated with buckle assemblies, tensioning devices, ratchet/lever systems, acceleration/deceleration sensors, and/or other aspects of personal restraint systems are not set forth below to avoid unnecessarily obscuring the description of various embodiments of the disclosure.

Many of the details, dimensions, angles, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below.

In the Figures, identical reference numbers identify identical or at least generally similar elements. To facilitate the discussion of any particular element, the most significant digit or digits of any reference number usually refers to the Figure in which that element is first introduced. For example, element 110 is first introduced and discussed with reference to FIG. 1.

FIG. 1 is an isometric view of a restraint system 100 having a buckle assembly 110 with a tensioning system 118 configured in accordance with an embodiment of the disclosure. In the illustrated embodiment, the restraint system 100 holds a vehicle occupant 10 (e.g., a child) in a child seat 101. In other embodiments, however, the restraint system 100 and/or the buckle assembly 110 can restrain other types of occupants in other vehicle seats. In further embodiments, the buckle assembly 110 can be used to restrain a child in a high-chair, swing, bicycle, stroller, or other seat.

In the illustrated embodiment, the child seat 101 includes a base portion 103 and a back portion 107. The child seat 101 can be secured to a vehicle seat 20 using various systems known in the art. Such systems can include, for example, belts or webs (not shown) having proximal ends attached to the child seat 101 and distal ends attached to anchors (also not shown) in the bight of the vehicle seat 20 with suitable couplings. In other embodiments, the child seat 101 can be secured to the vehicle seat 20, and/or other vehicle structures, using other suitable methods known in the art. Moreover, in further embodiments the child seat 101 or variations thereof can be reversed so that the child seat 101 is facing rearward toward the vehicle seat 20. Accordingly, as the foregoing illustrates, embodiments of the present disclosure and applications of the buckle assemblies and web connectors disclosed herein are not limited to the particular child seat configuration illustrated in FIG. 1.

In the illustrated embodiment, the restraint system 100 includes a first shoulder web 102a and a second shoulder web 102b extending from the back portion 107 of the child seat 101. The shoulder webs 102 can include various types of woven fabric materials and/or other suitable belt or strap materials known in the art that provide sufficient strength, flexibility, durability and/or other characteristics. In this embodiment, each of the shoulder webs 102 slidably passes through an aperture in a corresponding web connector 112 (identified individually as a first web connector 112a and a second web connector 112b). Passing the shoulder webs 102 through the web connectors 112 divides each of the shoulder webs 102 into a corresponding shoulder web portion 106 (identified individually as a first shoulder web portion 106a and a second shoulder web portion 106b), and a corresponding lap web portion 109 (identified individually as a first lap web portion 109a and a second lap web portion 109b). The end portions of the shoulder webs 102 can be secured or otherwise affixed to the child seat 101 and/or other adjacent structures using various methods known in the art.

Each of the web connectors 112 has a corresponding tongue portion (not shown) configured to releasably engage locking features in the buckle assembly 110 when inserted in the buckle assembly 110. In the illustrated embodiment, the buckle assembly 110 is attached to a distal end of a crotch web 105 that extends from the base portion 103 of the child seat 101. The proximal end of the crotch web 105 can be secured to the base portion 103 of the child seat 101 and/or other adjacent structures using various methods known in the art. The buckle assembly 110 can also include a release actuator or button 124, configured to release or disengage the tongue portions from the locking features of the buckle assembly 110 when a user depresses or otherwise actuates the button 124. Although FIG. 1 illustrates one possible use of the buckle assembly 110, those of ordinary skill in the art will appreciate that the buckle assembly 110 and the other components of the restraint system 100 can be used in a number of other restraint system applications without departing from the spirit or scope of the present disclosure.

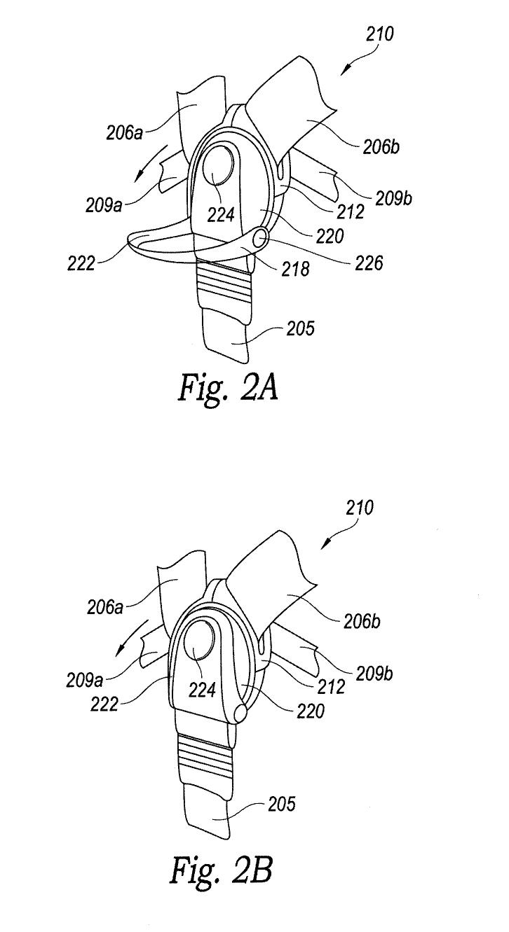

FIGS. 2A and 2B are enlarged front isometric views of the buckle assembly 110 illustrating operation of the tensioning system 118 in accordance with an embodiment of the disclosure. Referring to FIGS. 2A and 2B together, the tensioning system 118 has a tensioning lever 222 configured to rotate about a pivot 226. The tensioning lever 222 can pivot between an open or “untensioned” state (as shown in FIG. 2A) and a closed or “tensioned” state (as shown in FIG. 2B). As discussed in detail below, moving the tensioning lever 222 in this manner can increase the tension in a belt or web, such as a crotch web 205 that is operably coupled to the lever 222.

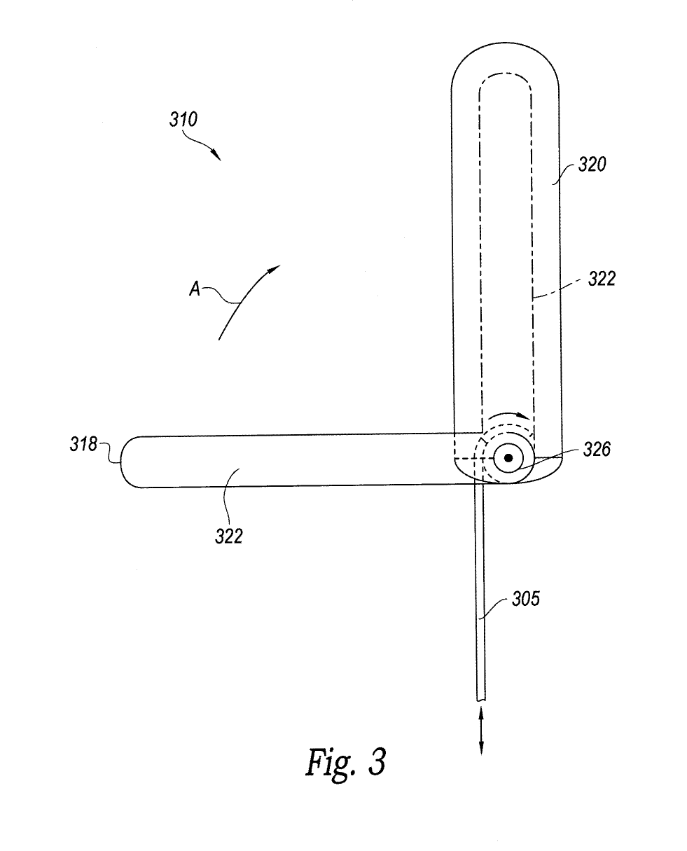

A user can secure a child or other occupant in a safety seat by inserting the web connectors 112 into the buckle assembly 110 in the manner discussed above with reference to FIG. 1. When doing so. shoulder webs 206 and the crotch web 205 may need to be adjusted for the size of the occupant. Gross adjustment of the webs 205, 206 can be achieved by manually pulling a loose end of each of the respective webs tighter or by changing the length of the shoulder webs 206 through adjusting means (not shown) on the shoulder webs 206. In one aspect of this invention, the user can then remove remaining slack in the restraint system by moving the tensioning lever 222 from the open position (FIG. 2A) to the closed position (FIG. 2B), as indicated by the arrow in FIG. 2A. As discussed in greater detail below with reference to FIGS. 3-8D, this rotation of the tensioning lever 222 can take in a length of crotch web 205, thereby increasing tension in the restraint system. The tensioning lever 222 can then be releasably held in the closed position by use of various engagement features known in the art (e.g., a ball detent, a spring, a snap or other connector), or simply by interfacing with the housing 220 or another portion of the buckle assembly 210.

In some embodiments, the length of the crotch web 205 removed from the system as slack can be from about ⅛ inch to about 1 inch. In one embodiment, the tensioning lever 222 can rotate between only two states—open and closed, thus taking in a fixed length of the crotch web 205 upon tensioning. In still other embodiments, the tensioning lever can be a 1-way ratchet system which can be rotated multiple times between the open and closed state, thus taking in an incremental length of the crotch web 205 upon each ratcheting stroke. While the illustrated embodiment shows the tensioning device 218 being used to tension the crotch web 205, in other embodiments the tensioning device 218 can alternately or additionally add tension to a shoulder or lap web.

In one embodiment, the tensioning system 218 can be unlatched by manually rotating the tensioning lever 222 from the closed position (FIG. 2B) to the open position (FIG. 2A), as shown by the arrow in FIG. 2B. In another embodiment, the tensioning system 218 can be unlatched by actuating a release button 224. In further embodiments, actuating the release button 224 a single time will release the tensioning lever 222, and actuating the button 224 a second time will release the web connectors 212 from the buckle assembly 210. In still other embodiments, actuating the release button 224 a single time both releases the web connectors 212 and opens the tensioning lever 222.

Slack in restraint systems (e.g. the restraint system 100 of FIG. 1) is often hidden. For instance, an occupant may be wearing blousing clothing or may be positioned in a way that it hides excess slack around the lap of the occupant or behind the child seat. Furthermore, the user may have to exert substantial force on the buckle assembly 210 to remove excess slack. As a result, users may be hesitant to try to remove some slack to avoid agitating the occupant. In such situations, the tensioning system 218 can remove excess web slack from the restraint system in a quick and effective manner.

FIGS. 3-5 are schematic side views of buckle assemblies 310, 410 and 510 respectively, having tensioning devices configured in accordance with additional embodiments of the disclosure. The tensioning devices depicted in FIGS. 3-5 can be used in various types of buckle assemblies, such as the buckle assembly 110 described above with reference to FIG. 2. Shoulder and/or lap webs have been omitted from FIGS. 3-5 for ease of illustration.

Referring first to FIG. 3, the buckle assembly 310 includes a tensioning device 318 having a tensioning lever 322 pivotally coupled to a buckle housing 320 by a pivot shaft 326. A web 305 (e.g. a crotch web) is at least partially wound around the pivot shaft 326. When the tensioning lever 322 is rotated in the direction of arrow A from an open position to a closed position, the web 305 is further wound around the pivot shaft 326, thereby retracting the web 305 and increasing the tension in the restraint system. In the illustrated embodiment, the web 305 is a crotch web. In other embodiments, the web 305 can be, for example, a shoulder web or any other suitable belt or strap material.

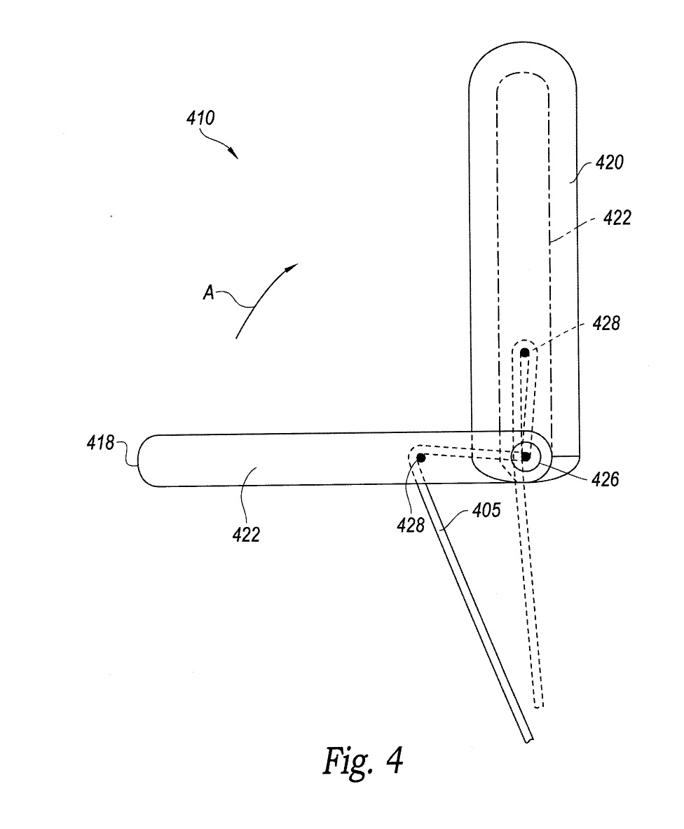

Referring next to FIG. 4, the buckle assembly 410 includes a tensioning device 418 having a tensioning lever 422 pivotally coupled to a buckle housing 420 by a pivot shaft 426. In the illustrated embodiment, a web 405 is attached to or at least partially wound around a shaft or web axle 428. When the tensioning lever 422 rotates in the direction of arrow A from an open position to a closed position, the web axle 428 rises, pulling the web 405 and creating more tension in the restraint system.

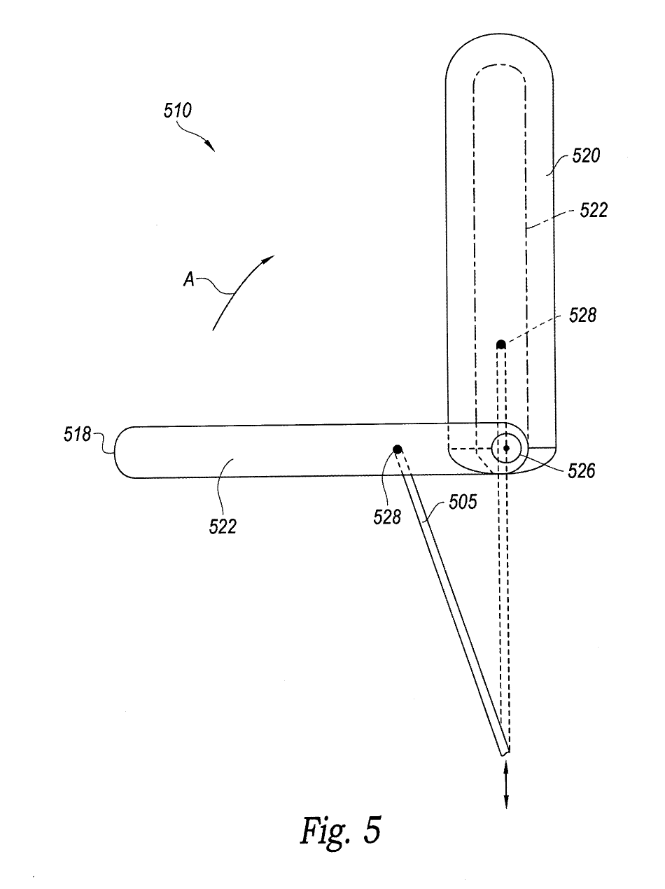

Referring next to FIG. 5, the buckle assembly 510 includes a tensioning device 518 having a tensioning lever 522 pivotally coupled by a buckle housing 520 to a pivot shaft 526. In the illustrated embodiment, a web 505 is attached (e.g. fixedly attached) to a shaft or pin 528. When the tensioning lever 522 rotates in the direction of arrow A from an open position to a closed position, the web pin 528 rises, pulling the web 505 and creating more tension in the restraint system.

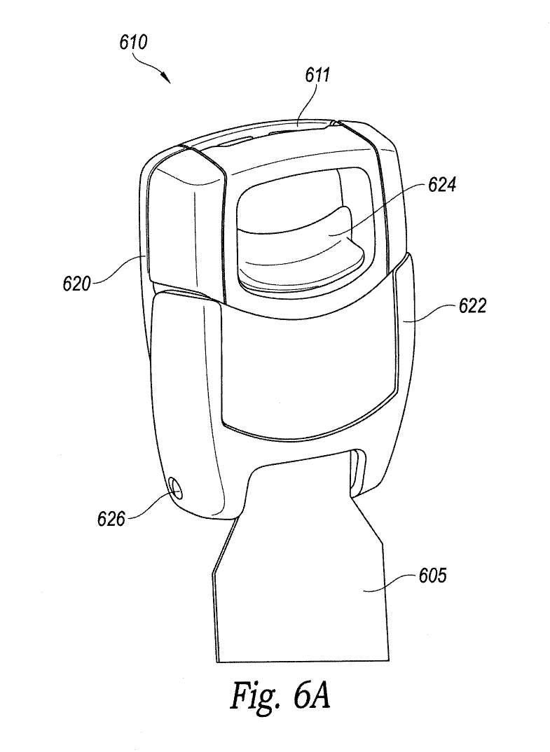

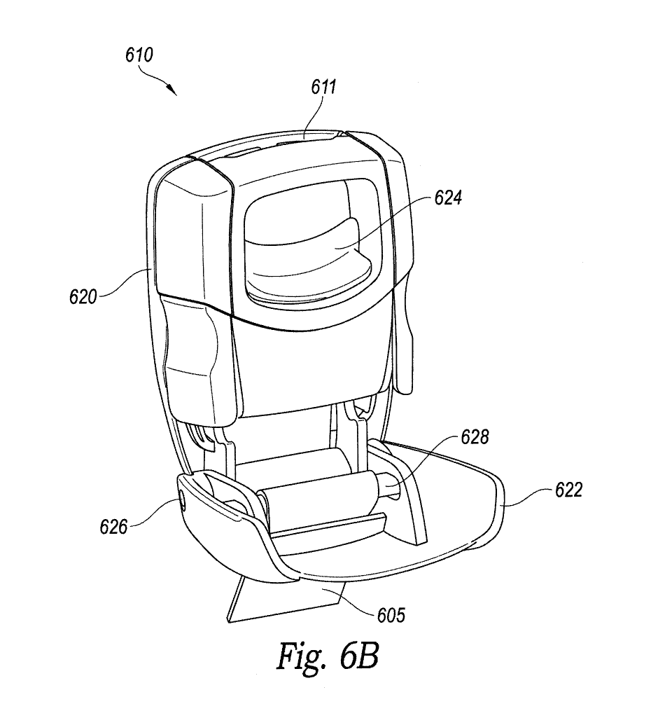

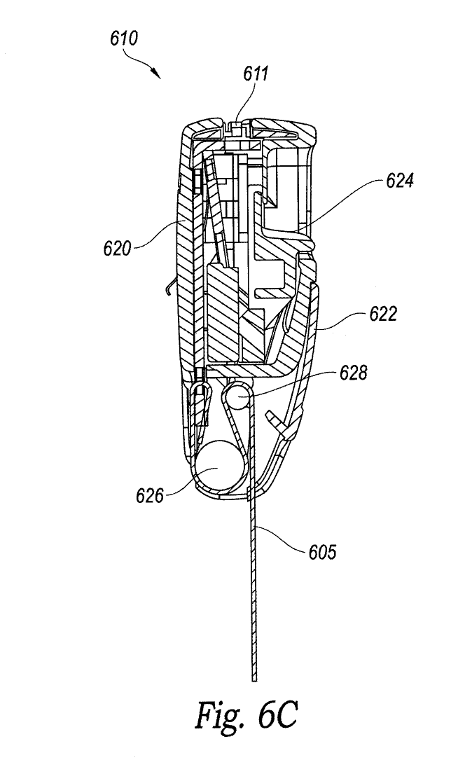

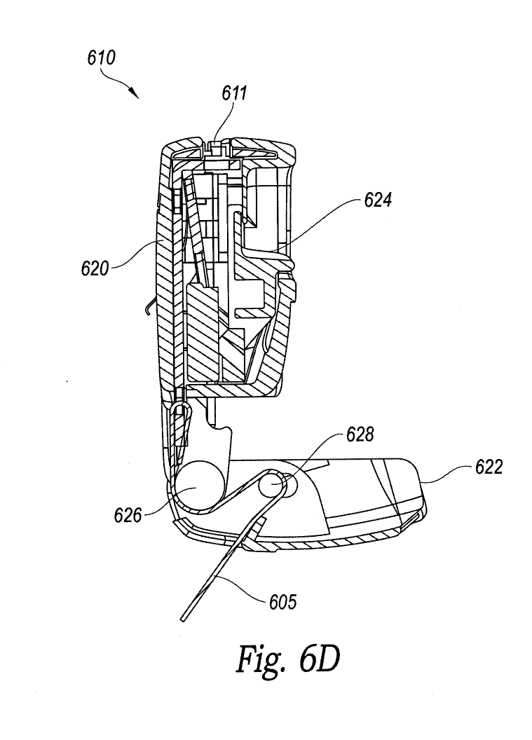

FIGS. 6A-6D depict a buckle assembly 610 having a tensioning lever 622 operably coupled to a buckle housing 620 configured in accordance with another embodiment of the disclosure. FIGS. 6A and 6B are front isometric views of the buckle assembly 610 in which the tensioning lever 622 is in a closed position in FIG. 6A and in an open position in FIG. 6B. FIGS. 6C and 6D are cross-sectional side views of the buckle assembly 610 showing the tensioning lever 622 in the closed position and the open positions, respectively.

The tensioning lever 622 is pivotally attached to the buckle assembly 610 by a pivot shaft 626 disposed through the buckle housing 620. A web 605 (e.g. a crotch web) is at least partially wound around the pivot shaft 626 and a web axle 628. In this embodiment, the pivot shaft 626 does not rotate relative to the buckle housing 628, and an end portion of the web 605 is fixedly attached to the buckle housing 620. When the tensioning lever 622 is rotated from an open position (as in FIGS. 6B and 6D) to a closed position (as in FIGS. 6A and 6C), the web 605 is further wound around the pivot shaft 626 and the web axle 628 rises, thereby increasing tension in the restraint system.

In the illustrated embodiment of FIGS. 6A-6D, the tensioning lever 622 has a shape that at least partially surrounds and complements the buckle housing 620. In other embodiments, the tensioning lever 622 can have an inverted U-shape (similar to the shape illustrated in FIGS. 2A and 2B above), a rectangular shape, a curved shape, or another shape altogether. In certain embodiments, for example, the tensioning system can be unlatched by actuating a release button 624 on the buckle assembly 610. In still further embodiments, the tensioning mechanism can include a dial, knob, screw, switch, or other device that is configured to cause tensioning by any of the means, methods, or mechanisms described herein.

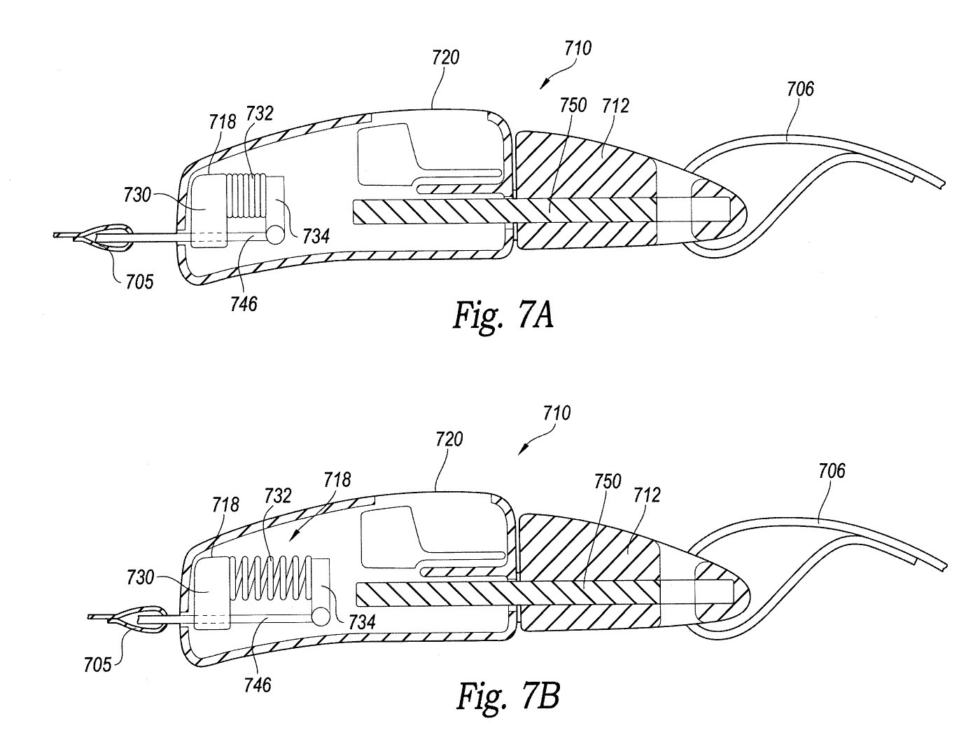

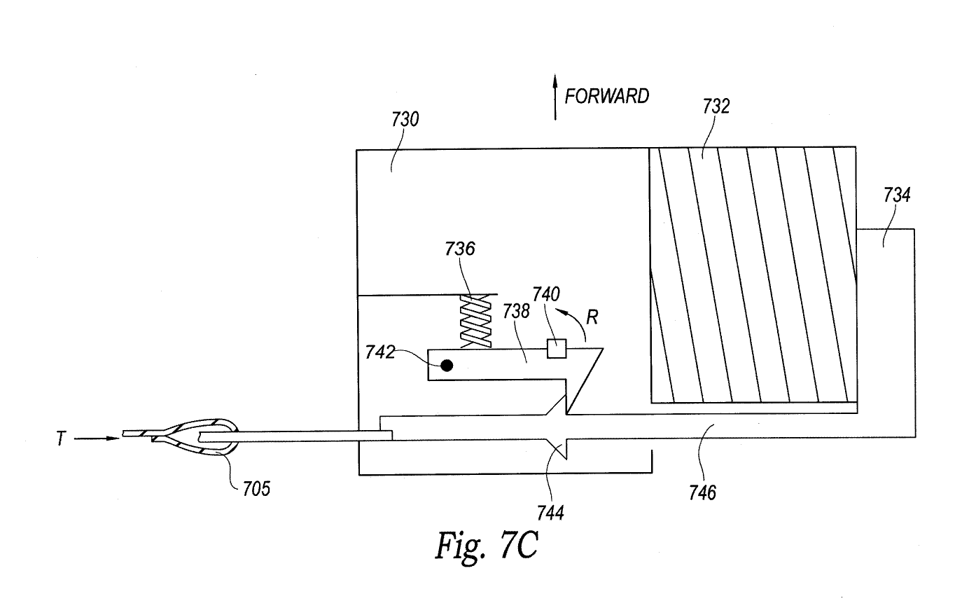

FIGS. 7A and 7B are cross-sectional side views of a buckle assembly 710 having a tensioning system 718 configured in accordance with another embodiment of the disclosure. FIG. 7C is an enlarged schematic side view illustrating one embodiment of a sensor portion 730 of the tensioning system 718 of FIG. 7A. Referring first to FIGS. 7A and 7B together, in this embodiment the tensioning system 718 can include a sensor 730 (e.g., a deceleration/acceleration sensor configured to detect a deceleration or acceleration event above a preset magnitude), a compressed spring 732, a spring restraint 734, and a spring-release rod 746. A web 705 (e.g. a crotch web) can be fixedly attached to a distal end portion of the spring-release rod 746. In alternate embodiments, the tensioning system 718 can alternately or additionally be attached to a shoulder and/or lap web. As described in detail below, the tensioning system 718 can be configured to alternate between a compressed or “untensioned” state (as shown in FIG. 7A) and a released or “tensioned” state (as shown in FIG. 7B).

According to one embodiment of the disclosure, the spring 732 can be held in an unextended position (FIG. 7A) by the spring restraint 734. The spring restraint 734 can be fixedly attached to a proximal end portion of the spring-release rod 746. The spring-release rod 746 can have one or more teeth 744. While in an untensioned state, the rod 746 is held in place by a pawl 738 that catches on the tooth 744. The pawl 738 and tooth 744 serve as a one-way ratchet device, preventing the rod 746 from releasing the compressed energy of the spring 732.

Referring to FIGS. 7A-7C together, in operation a user can secure an occupant (e.g. a child) in a safety seat and insert tongues 750 (one shown) of the web connectors 712 into the buckle assembly 710 in the manner discussed above with reference to FIG. 1. Gross slack in the shoulder webs 706 and the crotch web 705 can be taken up and adjusted as needed to secure the occupant by pulling on loose ends of the webs 705, 706.

In one embodiment, during a crash event, rapid deceleration of the vehicle causes a mass 740 on the pawl 738 to rotate in the direction of arrow R about a pivot point 742 and disengage the pawl 738 from the tooth 744. The spring-release rod 746 is thus released from the pawl 738, and the spring 738 drives the spring-release rod 746 and the web 705 in the direction of arrow T. When the web 705 is pulled in the direction of T, tension is added to the system, thereby further securing the occupant. In some embodiments the length of crotch web 705 that is removed from the system as slack can be from about ⅛ inch to about 2 inches.

In other embodiments, the spring restraint 734 can be released by a ball bearing on a track, a cage mechanism, or by other mechanical or electro-mechanical mechanisms and/or sensors known in the art. In one embodiment, for example, a solenoid (not shown) drives the spring-restraint 734 forward, thus releasing the spring and adding tension to the system in response to a crash signal. In this embodiment, the solenoid may have a battery or an external power source (e.g., a vehicle battery) to provide electrical power. In another embodiment, a yoke and gimble can be used as a deceleration sensor. In yet another embodiment, a pendulum can sense the deceleration and release the spring-release rod 746 to thereby tension the web 705.

In one embodiment, the spring 732 can be manually re-compressed and engaged by the tooth 744 after the crash event, thus restoring a comfortable amount of slack to the occupant. For example, the spring 732 can be re-compressed by moving the spring-release rod 746 in a direction opposite arrow T. The pawl 738, having been restored to its non-activated state by a return spring 736, again catches the tooth 744 of the rod 746, and prevents the spring 732 from releasing its compressed energy.

In other embodiments, there can be other configurations for restoring the spring 732 to an unreleased state. In some embodiments the restoration can be based on the timing of the crash event. In one embodiment, for example, the acceleration detector 730 has an electronic sensor and an associated restoration means that restores the spring 732 to an unreleased state after a fixed period of time after the crash event. In other embodiments a solenoid can be used to put tension on the spring 732 and release that tension either after a fixed period of time or after a sensor indicates that the crash event has passed.

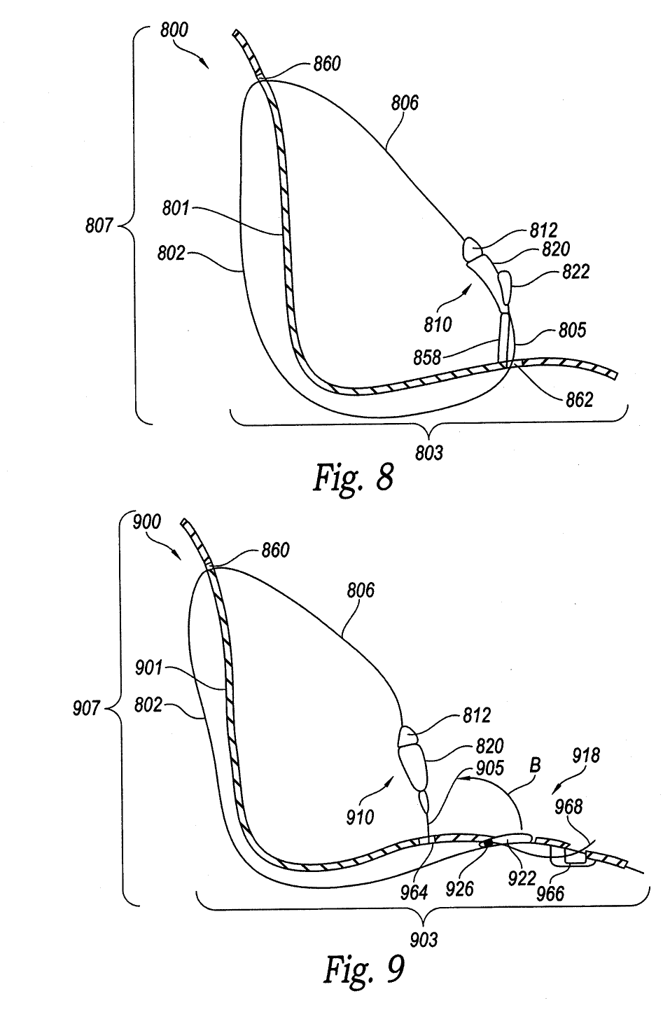

FIGS. 8-11 are side cross-sectional views of safety seats having various buckle assemblies and tensioning devices configured in accordance with embodiments of the disclosure. In the embodiment of FIG. 8, a restraint system 800 includes a safety seat 801 having a back portion 807 and a base portion 803. A first end portion of a shoulder web 802 slidably passes through an aperture 860 in the back portion 807 of the safety seat 801. A second end portion of a shoulder web 802 slidably passes through an aperture 860 in the back portion 807, around the rear of the back portion 807, and through a second aperture 862 in the base portion 803. Passing the shoulder web 802 through the aperture 860 divides the shoulder web 802 into a corresponding shoulder web portion 806. Similarly, passing the shoulder web 802 through the aperture 862 divides the shoulder web 802 into a corresponding crotch web portion 805. The crotch web portion 805 is operably coupled to a lever 822, which is operably coupled to a buckle body 820. The buckle body 820 is releasably joined to a connector 812, which is operably coupled to the shoulder web portion 806.

A semi-flexible member 858 operably couples the buckle body 820 to the base portion 803. The semi-flexible member 858 can be configured to maintain the buckle body 820 at a fixed position to facilitate attachment to the connector 812. In certain embodiments, the semi-flexible member 858 can include a spring element (not shown) that is configured to displace the semi-flexible member 858 downward, allowing for greater ease in removing an occupant of the safety seat 801. In some embodiments, the semi-flexible member 858 can be made from, for example, hard rubber or foam. In other embodiments, the semi-flexible member can be made of plastic and/or other suitable materials known in the art. Moreover, portions of the semi-flexible member 858 can include a durable finish to protect against damage.

The tensioning lever 822 on the buckle body 820 can alternate between an open position or a closed position in the manner described above of the tensioning levers 222, 322, 422, 522, and 622. If the tensioning lever 822 is in the open position, or untensioned state, a longer length of the crotch web 805 is available, thus reducing tension in the crotch web 805 and the shoulder web 802 and facilitating easier removal of an occupant of the restraint system 800. Conversely, if the tensioning lever 822 is in the closed position, a shorter length of the crotch web 805 is available, thus increasing tension in the crotch web 805 and shoulder web 802 and securing further the occupant in the restraint system 800.

FIG. 9 depicts a restraint system 900 including a safety seat 901 having a back portion 907 and a base portion 903, configured in accordance with another embodiment of the disclosure. In contrast to the embodiment of FIG. 8, the buckle body 820 is attached to the base portion 903 by a crotch web 905 fixedly attached to an anchor 964 on the base portion 903. A second end portion 968 of the shoulder web 802 is operably coupled to a tensioning system 918 having a tensioning lever 922 disposed in the base portion 903. The tensioning lever 922 is configured to rotate around a pivot shaft 926 and can alternate between an open position or a closed position in the manner described above of the tensioning levers 222, 322, 422, 522, and 622. If the tensioning lever 922 is in the open position, or untensioned state, a longer length of the shoulder web 802 is available, thus reducing tension in the shoulder web 802 and the shoulder web portion 806 and facilitating easier removal of an occupant of the restraint system 900. Conversely, if the tensioning lever 922 is in the closed position, a shorter length of the shoulder web 802 is available, thus increasing tension in the shoulder web 802 and the shoulder web portion 806 and securing further the occupant in the restraint system 900. In the illustrated embodiment, the lever 922 is in the closed position. However, rotation of the lever 922 in the direction of arrow B can move the lever 922 into the open position.

Gross adjustment of the tension in the shoulder web 802 can be achieved when the tensioning lever 922 is in the open position by the manual pulling of the second end portion 968 through a web adjuster 966 in and/or on the base portion 903. Pulling on the second end portion 968 can increase tension in the shoulder web 802 and the shoulder web portion 806. The tension caused by pulling on the second end portion 968 can be maintained by closing the tensioning lever 922 and/or securing the second end portion 968 by engaging the web adjuster 966. The web adjuster 966, when engaged, can be configured to hold, grab, or otherwise prevent the second end portion 968 from slidably passing so that tension in the shoulder web 802 is maintained. In some embodiments, the web adjuster 966 can be a clamp. In other embodiments, the web adjuster 966 can be a buckle, a fastener, or another web adjustment means known in the art.

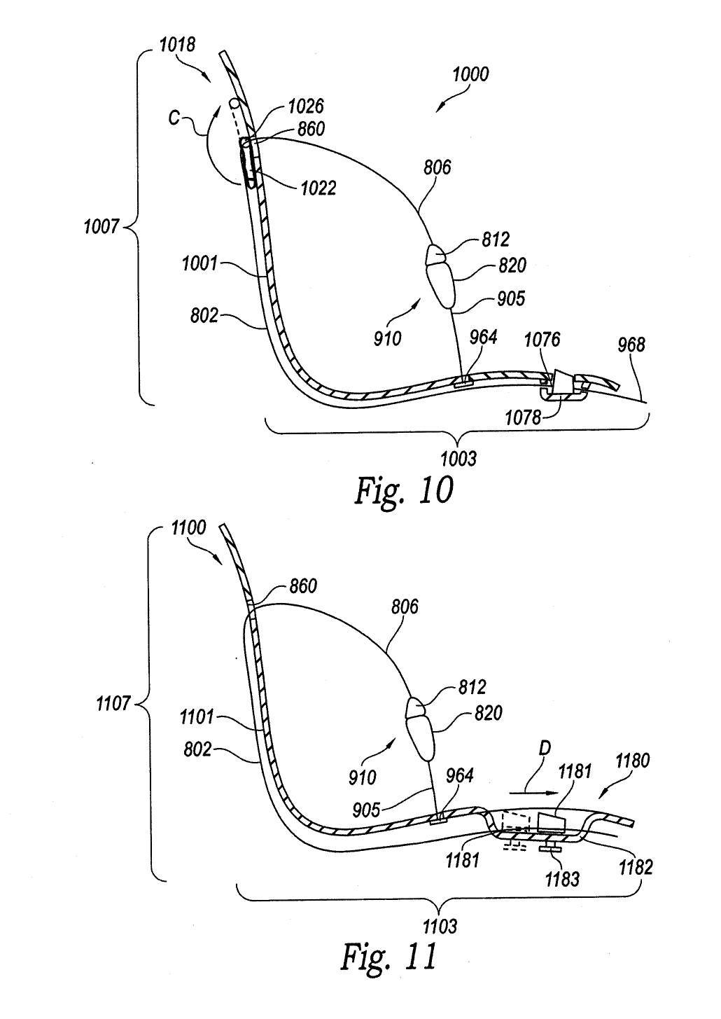

FIG. 10 depicts a restraint system 1000 including a safety seat 1001 having a back portion 1007 and a base portion 1003, configured in accordance with a further embodiment of the disclosure. The restraint system 1000 also includes a tensioning system 1018 having a tensioning lever 1022 disposed on a rear surface of the back portion 1007. The tensioning lever 1022 is configured to rotate around a pivot shaft 1026 and can alternate between an open position or a closed position in the manner described above of the tensioning levers 222, 322, 422, 522, and 622. If the tensioning lever 1022 is in the open position, or untensioned state, a longer length of the shoulder web 802 is available, thus reducing tension in the shoulder web 802 and the shoulder web portion 806 and facilitating easier removal of an occupant of the restraint system 1000. Conversely, if the tensioning lever 1022 is in the closed position, a shorter length of the shoulder web 802 is available, thus increasing tension in the shoulder web 802 and the shoulder web portion 806 and securing further the occupant in the restraint system 1000. In the illustrated embodiment, the lever 1022 is in the open position. However, rotation of the lever 1022 in the direction of arrow C can move the lever 1022 from the open position to the closed position, thus increasing tension in the shoulder web 802.

Gross adjustment of the tension in the shoulder web 802 can be achieved when the tensioning lever 1022 is in the open position by the manual pulling of the second end portion 968 slidably passing through a web adjuster 1076. Pulling on the second end portion 968 can increase tension in the shoulder web 802 and shoulder web portion 806. The tension caused by pulling on the second end portion 968 can be maintained by closing the tensioning lever 1022 and/or securing the second end portion 968 with the web adjuster 1076. The web adjuster 1076, once engaged, can be configured to hold, grab, or otherwise prevent the second end portion 968 from slidably passing so that tension in the shoulder web 802 is maintained. In the illustrated embodiment, the web adjuster is disposed in a recessed portion 1078 of the base portion 1003. In certain embodiments, however, the web adjuster 1076 can be disposed at any position on the safety seat 1001. Furthermore, in some embodiments, the web adjuster 1076 can be a clamp, while in other embodiments, the web adjuster 1076 can be a buckle, a fastener, or another web adjustment means known in the art.

FIG. 11 depicts a restraint system 1100 including a safety seat 1101 having a back portion 1107 and a base portion 1103, configured in accordance with yet another embodiment of the disclosure. The restraint system 1100 further includes a tensioning system 1180 configured to adjust the tension in the shoulder web 802 and the shoulder web portion 806. The shoulder web 802 is operably coupled to a lockable web adjuster 1181, which is releasably and slidably disposed in a slot or a track 1181 in a substructure 1182 of the base portion 1103. In the illustrated embodiment, the web adjuster 1181 has a release 1183, which, when engaged by an operator, can disengage a locking mechanism configured to lock the web adjuster 1181 at a position the on track 1181. When the locking mechanism is released, the web adjuster 1181 can be configured to slidably move in the direction of arrow D from a first position to a second position thereby removing slack from the shoulder web 802 and the shoulder web portion 806, and increasing tension in the restraint system 1100. In some embodiments, the release 1183 can be a spring-loaded actuator that allows the locking mechanism to remain disengaged from the track 1181 only while the operator actuates the release 1183. In other embodiments, the release 1183 can be a lever that can be opened by the operator, allowing the web adjuster 1181 to slidably and freely move along track 1181 until the operator closes the lever and re-engages the locking mechanism. In further embodiments, the release 1183 can be a clamp, a button, or any other suitable locking mechanism release in the art.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the invention. Accordingly, the disclosure is not limited, except as by the appended claims.

I/We claim:

1. A personal restraint system for use with a child seat in a vehicle, the personal restraint system comprising:
a connector configured to be operably coupled to a first web, wherein the connector includes a tongue portion having a locking feature; and
a buckle assembly, the buckle assembly including:
a buckle body configured to be operably coupled to a second web, wherein the buckle housing includes an aperture configured to receive the tongue portion;
a latch in the buckle body configured to engage the locking feature of the tongue portion to thereby lock the connector and buckle body together when the tongue portion is inserted into the buckle body through the aperture; and
a lever operably coupled to the buckle body, wherein manual rotation of the lever between a first position and a second position adjusts tension in the second web.

2. The personal restraint system of claim 1 wherein the buckle assembly further includes an actuator coupled to the latch, wherein actuation of the actuator disengages the locking feature of the tongue portion from the latch.

3. The personal restraint system of claim 1 wherein the lever is configured to increase tension to the second web in the first position and reduce tension in the second web in the second position.

4. The personal restraint system of claim 1 wherein rotating the lever to the first position includes pivotal rotation of the lever toward the buckle housing.

5. The personal restraint system of claim 1 wherein rotating the lever to the second position includes pivotal rotation of the lever away from the buckle body.

6. The personal restraint system of claim 1 further comprising a ratchet system, wherein rotation of the lever operates the ratchet system to adjust the tension in the second web.

7. The personal restraint system of claim 1 wherein the first web is a shoulder web of a child seat and the second web is a crotch web of the child seat.

8. The personal restraint system of claim 1 wherein rotating the lever from the first position comprises actuating the actuator.

9. The personal restraint system of claim 1 wherein a length of a proximal end portion of the second web is circumferentially disposed around a pivot, and wherein rotation of the lever changes the length of the proximal end portion disposed around the pivot.

10. The personal restraint system of claim 9 further comprising a web support attached to the lever wherein a length of a distal portion of the second web extends around the web support.

11. The personal restraint system of claim 10 wherein the proximal end portion of the second web passes around the web support and is attached to the pivot.

12. The personal restraint system of claim 10 wherein the proximal end portion of the second web is fixedly attached to the web support.

13. A buckle assembly for use with a personal restraint system in a vehicle, the buckle assembly comprising:
a buckle body configured to be operably coupled to a web; and
a tensioning system operably disposed in the buckle body, the tensioning system including:
an elongated member attached to the web;
a release mechanism;
a spring having a first end operably coupled to a spring restraint rigidly attached to the elongated member,
wherein the spring is configured to be compressed when the release mechanism engages the elongated member and decompressed with the release mechanism disengages the elongated member; and
a sensor operably coupled to a second end of the spring and configured to detect an rapid deceleration and/or acceleration event, wherein detection of the rapid deceleration and/or acceleration event by the sensor causes the release mechanism to disengage the elongated member thereby allowing the spring to decompress and increasing tension in the web.

14. The buckle assembly of claim 13 wherein the release mechanism comprises a pawl releasably engaging a tooth of the elongated member.

15. The buckle assembly of claim 14 further comprising a return spring compressionally coupled to the pawl and configured to restore the position of the pawl after the rapid deceleration and/or acceleration event and subsequent disengagement by the pawl of the rod.

16. A child restraint system for use in a vehicle, the restraint system comprising:
a child safety seat having a base portion and a back portion;
a first web having a first end portion and a second end portion wherein the first web is configured to slidably pass through a first aperture in the back portion of the safety seat and extend adjacent to a rear surface of the back portion
a connector coupled to the first end portion of the first web and configured to releasably engage a buckle assembly coupled to a second web; and
a tensioning device operably coupled to the second end portion of the first web, wherein the tensioning device is configured to increase tension in the first web at a first position of the tensioning device and decrease tension in the first web at a second position of the tensioning device.

17. The occupant restraint system of claim 16 wherein the tensioning device includes a lever that is configured to rotate around a pivot and wherein at least a portion of the first web is circumferentially disposed around the pivot.

18. The occupant restraint system of claim 17 wherein the lever is closed at the first position and open at the second position.

19. The occupant restraint system of claim 16 wherein the tensioning device includes a lockable web adjuster configured to be slidably displaced between the first position and the second position.

20. The occupant restraint system of claim 16 wherein the second web is a semi-flexible member configured to hold the buckle assembly at a fixed position.
